(19) United States
(12) Patent Application Publication
(10) Pub. No.: US 2001/0045032 A1
(43) Pub. Date: Nov. 29, 2001

(54) Excavation control mounting mast

(76) Inventor: Charles P. Kleffner, Bigfork, MT (US)

Correspondence Address: Burkhart & Burkhart, Patent Attorneys, 940 Dakota Ave., Whitefish, MT, 59937, US

(21) Appl. No.: 09/766,999

(22) Filed: Jan. 23, 2001

Related U.S. Application Data
(60) Provisional application No. 60/196,560, filed on Apr. 11, 2000.

(51) Int. Cl. E01C 23/07; G06F 19/00

(52) U.S. Cl. 37/466; 404/84.5; 701/50; 56/10.2 F

(57) ABSTRACT

A mast assembly is adapted for attachment to an excavating apparatus such as a loader bucket of a skid steer vehicle such as a BOBCAT. The excavating apparatus includes a rear wall, a pair of side walls, and a bottom. The mast assembly includes a mast, which can be fabricated from any suitable relatively rigid and durable material, such as aluminized steel. The mast includes an upper portion and a lower portion connected by an angled portion angled to maintain the upper portion in an upright vertical position. A laser receiver is secured to the upper portion of the mast with a pair of adjustable securing straps. The laser receiver operates in a known manner to receive laser energy from a laser beacon to facilitate accurate positioning of the excavating apparatus. A first removable securing member, such as a hook arrangement or latch bracket, is affixed to the mast. The hook arrangement can include a pair of hooks which extend through a corresponding number of bores formed in the excavating apparatus. The latch bracket can include a pair of latch points that fit into an adapter plate. A second removable securing member, such as a magnet, is connected to the mast. The second securing member is attached to the mast by a pair of adjustable securing straps, or by a pivotable bracket. The magnet should have sufficient strength to secure the mast to the excavating apparatus such that the mast remains fixed during excavation.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

The invention relates generally to mounting masts for excavating equipment. In particular, the invention relates to readily mountable and demountable mounting masts for laser receivers.

### DESCRIPTION OF RELATED ART

With increased needs for ever more efficiency and accuracy in excavation, excavation technology has progressed from sharpened stones to the pickaxe and shovel, from steam shovels to modern laser-guided excavators. Laser-guided excavators range from simple elevation guides to sophisticated systems using digitized topographic maps and multiple laser sources and sensors to determine precise operating positions for excavating equipment.

Laser-assisted excavators are well-represented in the patent literature. For example, U.S. Pat. No. 3,825,808 to Teach is directed to a power-driven extensible mast for mounting a photocell unit which is utilized to detect a laser beam which is periodically swept over a working area at a known elevation.

In U.S. Pat. No. 4,034,490, also to Teach, the cutting depth of an endless chain type trencher is normally determined by the angle of the frame carrying the endless chain relative to the horizontal. In accordance with this invention, the angular position of the digging frame is controlled by one or more hydraulic cylinders which, in turn, are controlled by signals derived from sensors carried by an upstanding vertical mast mounted to the frame which detects a reference plane defined by a rotating laser beam. A trigonometric correction factor to compensate for the mast mounting is included.

U.S. Pat. No. 4,393,606 to Wamecke discusses a trench hoe-type excavator which carries a digging bucket at the end of a digging device. The bucket and digging device are capable of being driven so as to maintain a set cutting angle. An indicating apparatus arranged in the field of view of the excavator operator allows the operator to check the position of the digging device to determine the direction in which the bucket must be guided in order to obtain the desired inclination and direction of the ditch floor. The indicator apparatus includes a laser transmitter and a transparent target. The transparent target is carried by the digging device and has a first surface facing the bucket operator and a second surface which is arranged to receive the laser beam from the laser transmitter. The laser transmitter is arranged on the opposite side of the target from the excavator operator, so that the position of the end point of the laser beam on the target can be observed, parallax-free, by the excavator operator during the entire digging operation.

U.S. Pat. No 5,812,721 to Ingvarsson is directed to a system and method for monitoring light using a photosensitive mast mounted on a support or machine. A light signal, such as a laser, is detected by the photosensitive mast which has a plurality of optical fibers distributed longitudinally along and completely around the mast. The optical fibers are of lengths which differ by very small amounts, thereby creating any desired resolution of the photosensitive mast. The optical fibers are connected to a collecting device for gathering the light signals and determining the position of the light measuring device relative to the rotating laser light source.

U.S. Pat. No. 5,951,612 to Sahm shows a method and apparatus for determining at least one of the pitch and slope of an implement on an earthmoving machine. The apparatus includes a mast connected to an upper corner of the implement, a first set of laser detectors connected to the mast, a second set of laser detectors connected to the mast, a third set of laser detectors connected to the mast, and a computer adapted to receive signals from the first, second, and third sets of laser detectors and responsively determine the angle of pitch and the angle of slope of the implement.

While these devices provide for accurate excavation, they are relatively complex and correspondingly expensive. Since secure positioning is critical, the masts on which laser receivers are mounted are typically secured to the vehicles with permanently affixed mounting arrangements. As a consequence, such devices are generally mounted on high-end excavating and grading equipment, and are thus priced out of the market for lighter-duty applications such as skid-steer vehicles. It can be seen from the foregoing that the need exists for a laser receiver mount for excavators that will overcome the difficulties of known arrangements.

### SUMMARY

These and other objects are achieved by the provision of a mast assembly for mounting guidance components to an excavator component of an excavating vehicle. The mast assembly includes a mast, with a magnetic removable securing member connected to the mast. The magnetic removable securing member is adapted and constructed for removable connection to a location on the excavator component.

In another embodiment, the mast assembly includes a mast with first and second removable securing members connected to the mast. The first removable securing member is adapted and constructed for removable connection to a first location on the excavator component. The second removable securing member is adapted and constructed for removable connection to a second location on the excavator component. At least one of the removable securing members includes a magnet.

A method of securing a mast assembly to an excavator component is also provided. In a first step, a mast assembly is provided. The mast assembly includes a first removable securing member connected to the mast and including at least one insertion member, and a second removable securing member connected to the mast at a location spaced from the first removable securing member and including a magnet. Receiving structure is provided on the excavator component of the excavating vehicle. The receiving structure is capable of receiving the at least one insertion member of the first removable securing member. Next the mast assembly is angled so that the second securing member is spaced from the excavator component. The insertion member is then inserted into the receiving structure, and the mast assembly is rotated to bring the second securing member into magnetic contact with the excavator component.

The features of the invention believed to be patentable are set forth with particularity. The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 is a schematic side elevational view of a first embodiment of a laser receiver mast arrangement in accordance with the principles of the present invention.

FIG. 2 is a schematic front elevational view of a first embodiment of a laser receiver mast arrangement.

FIG. 3 illustrates a schematic block diagram of a control system having utility with a laser receiver mast arrangement in accordance with the principles of the present invention.

FIG. 4 is a schematic side elevational view of another embodiment of a laser receiver mast arrangement in accordance with the principles of the present invention.

FIG. 5 is a schematic side elevational view of another embodiment of a laser receiver mast arrangement in accordance with the principles of the present invention.

FIG. 6 is a top plan view of a latch bracket used in the FIG. 5 embodiment.

FIG. 7 is a top plan view of an adapter plate used in the FIG. 5 embodiment.

### DETAILED DESCRIPTION OF A PREFERRED EMBODIMENT

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

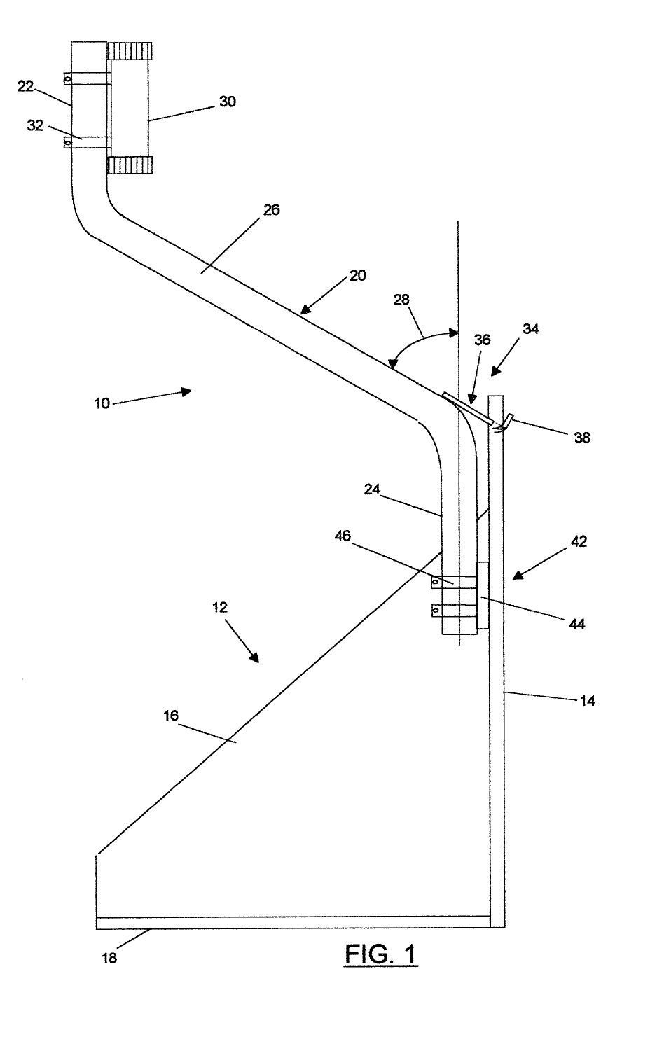

A mast assembly 10 is shown in FIG. 1. The mast assembly 10 is adapted for attachment to an excavating apparatus 12, here illustrated as a loader bucket of a skid steer vehicle such as a BOBCAT. The excavating apparatus 12 includes a rear wall 14, a pair of side walls 16, and a bottom 18.

The mast assembly 10 includes a mast 20. The mast 20 can be fabricated from any suitable relatively rigid and durable material, such as aluminized steel. The mast 20 includes an upper portion 22 and a lower portion 24. The upper portion 22 and lower portion 24 are connected by an angled portion 26. The angled portion 26 is angled to maintain the upper portion 24 in an upright vertical position. In the illustrated example, the angled portion 26 is offset at an angle 28 measuring approximately 45 degrees from the upper portion 22, although it is contemplated that the actual angle will depend upon the construction of the specific excavating apparatus.

A laser receiver 30 is secured to the upper portion 22 of the mast 20 with a pair of adjustable securing straps 32. The laser receiver 30 operates in a known manner to receive laser energy from a laser beacon (not shown) to facilitate accurate positioning of the excavating apparatus 12. One example of a commercially available receiver is the C.A.B. Receiver available from Laser Alignment, Inc. Of Grand Rapids, Mich.

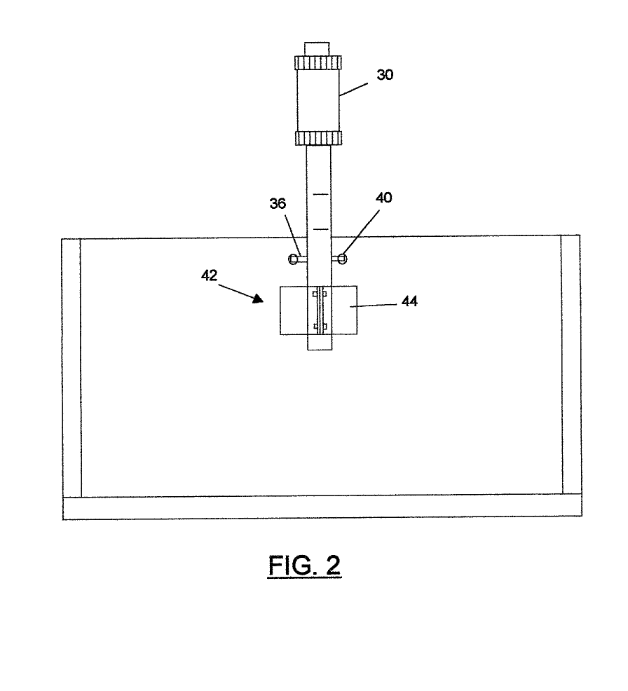

A first removable securing member 34, here shown as a hook arrangement 36, is affixed to the angled portion 26 of the mast 20. As shown in FIG. 2, the hook arrangement 36 includes at least one hook, here shown as a pair of hooks 38. The hooks 38 extend through a corresponding number of bores 40 formed in the excavating apparatus 12.

A second removable securing member 42 is connected to the lower portion 24 of the mast 20. The securing member 42 is here shown as a magnet 44, and is secured to the mast 20 by a pair of adjustable securing straps 46. The magnet 44 should have sufficient strength to secure the mast 20 to the excavating apparatus 12 such that the mast remains fixed during excavation. One example of a suitable magnet is commercially available from JOB MASTER.

The mast assembly 10 is mounted to the excavating assembly by angling the mast assembly 10 so that the second securing member 42 is away from the rear wall 14 of the excavating assembly 12. The hooks 38 are then inserted into the bores 40, and the mast assembly is rotated to bring the second securing member 42 into contact with the rear wall 14 of the excavating assembly 12. With the mast assembly 10 thus secured, the laser receiver 30 can be operated as usual.

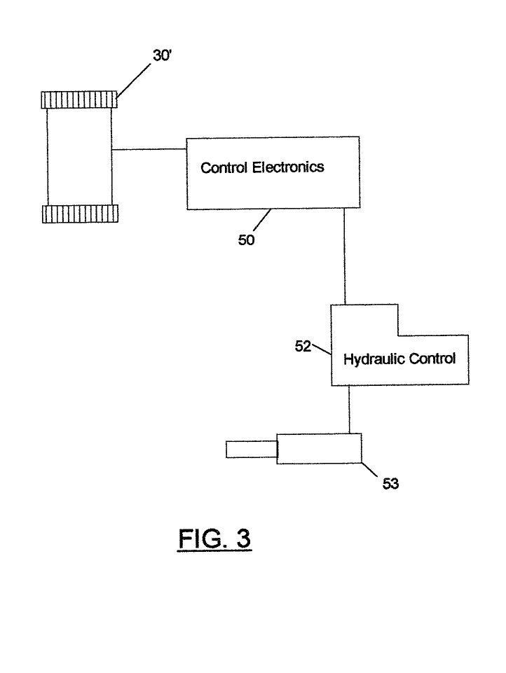

FIG. 3 illustrates a schematic diagram of an excavation arrangement in which a laser receiver 30′ is connected to control electronics 50. The control electronics 50 are in turn connected to a hydraulic control system 52, which is adapted to operate hydraulic actuators 54. A desired excavating parameter, for example, grade level, is entered into the control electronics 50. As the excavating apparatus is operated, the laser receiver 30′ generates signals corresponding to the excavating parameter. The control electronics 52 then generate control signals to the hydraulic actuators 54 to correct the position of the excavating apparatus as necessary.

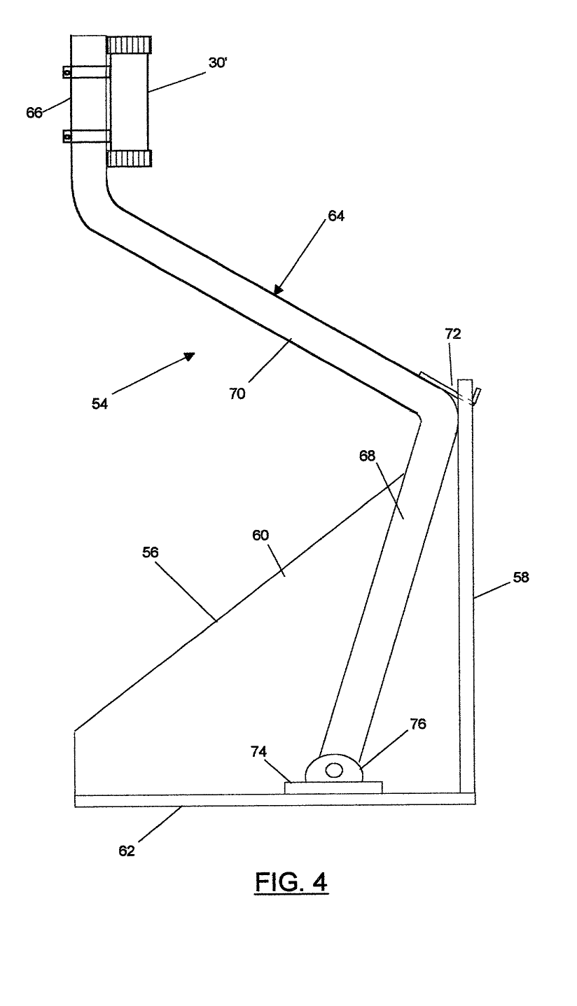

An alternative embodiment of a mast assembly 54 is shown in FIG. 4. The mast assembly 54 is adapted for attachment to an excavating apparatus 56, here illustrated as a loader bucket of a skid steer vehicle such as a BOBCAT. The excavating apparatus 56 includes a rear wall 58, a pair of side walls 60, and a bottom 62.

The mast assembly 54 differs from the mast assembly 10 shown in FIG. 1 in its mounting position in the excavating apparatus 56. The mast assembly 54 includes a mast 64, which can be fabricated from any suitable relatively rigid and durable material, such as aluminized steel. The mast 64 includes an upper portion 66 and a lower portion 68. The upper portion 66 and lower portion 68 are connected by an angled portion 70. A first removable securing member, here shown as a hook arrangement 72, is affixed to the angled portion 70 of the mast 64. The hook arrangement 72 is similar to that shown in FIGS. 1 and 2.

A second removable securing member 74 is connected to the lower portion 68 of the mast 64 via a pivotable bracket 76. The securing member 74 is here shown as a magnet 78 having sufficient strength to secure the mast 64 to the excavating apparatus 56 such that the mast remains fixed during excavation. One example of a suitable magnet is commercially available from JOB MASTER.

The mast assembly 54 is mounted to the excavating assembly by angling the mast assembly 54 so that the second securing member 74 is away from the rear wall 58 of the excavating assembly 56. The hooks of the hook arrangement 72 are then inserted into bores in the rear wall 58, and the mast assembly is rotated to bring the second securing member 74 into contact with the bottom wall 62 of the excavating assembly 56. With the mast assembly 54 thus secured, the laser receiver 30′ can be operated as usual.

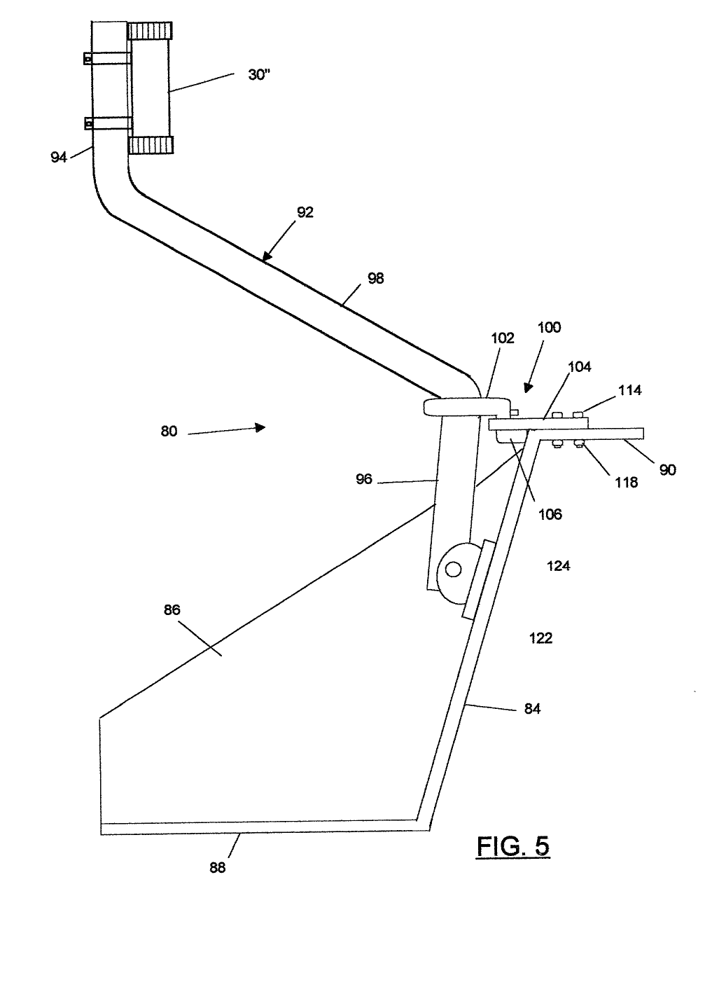

Another alternative embodiment of a mast assembly 80 is shown in FIG. 5. The mast assembly 80 is adapted for attachment to an excavating apparatus 82, here illustrated as a loader bucket of a skid steer vehicle such as a BOBCAT. The excavating apparatus 82 includes a rear wall 84, a pair of side walls 86, a bottom 88, and a rear extension 90.

The mast assembly 80 differs from the mast assembly 10 shown in FIG. 1 in its mounting position in the excavating apparatus 82. The mast assembly 80 includes a mast 92, which can be fabricated from any suitable relatively rigid and durable material, such as aluminized steel. The mast 92 includes an upper portion 94 and a lower portion 96. The upper portion 94 and lower portion 96 are connected by an angled portion 98. A first removable securing member, here shown as a latch assembly 100, is affixed to the angled portion 98 of the mast 80.

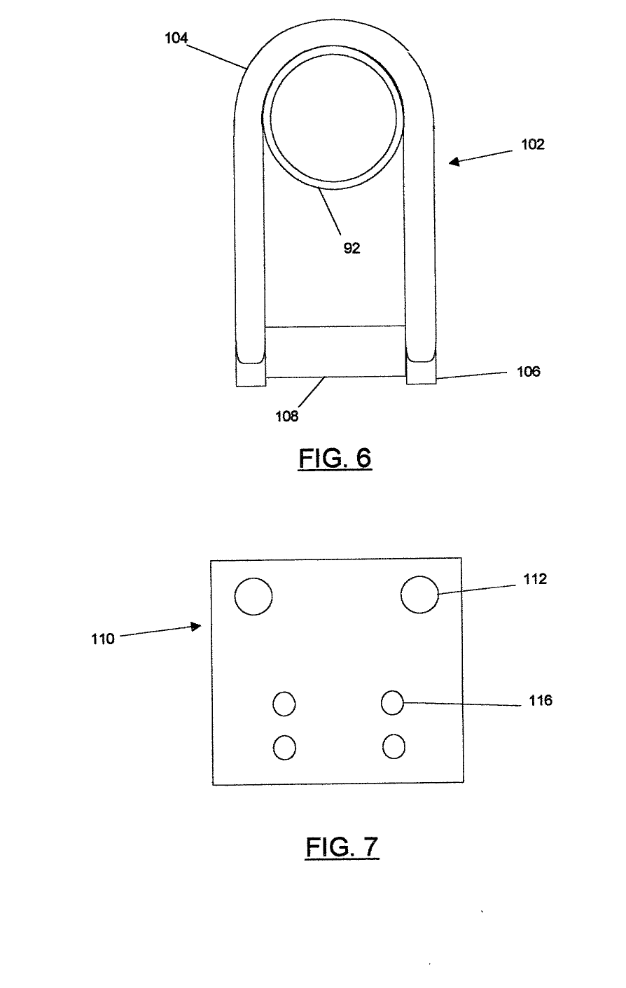

The latch assembly 100 includes a latch bracket 102. As shown in FIGS. 5 and 6, the latch bracket 102 includes a curved mast attachment portion 104, here the latch bracket 102 is rigidly secured to the mast 92, such as by welding. A pair of latch points 106 extend downwardly and outwardly from the curved mast attachment portion 104. It has been found that a downward angle of approximately 75° to 80° provides suitable results. A flat strap 108 is secured between the latch points 106, for example, by welding. The flat strap 108 acts as a fulcrum to facilitate mast installation and removal, and also acts as an insertion limiter, as will be described.

The latch assembly 100 also includes an adapter plate 110. As shown in FIGS. 5 and 7, the adapter plate 110 includes a pair of insertion holes 112 adapted to receive the latch points 106 of the latch bracket 102. The inner diameter of the insertion holes 112 is slightly greater than the outer diameter of the latch points 106. It has been found that, when using a mast having an outer diameter of 2 inches, fabricating the latch bracket from ½ inch diameter rod steel provides a suitable structure. The adapter plate 110 is secured to the rear extension 90 of the excavating apparatus 82 by any suitable fastening arrangement. In the illustrated embodiment, a plurality of threaded screws 114 are inserted through bores 116 in the adapter plate 110 and the rear extension 90, then secured with a plurality of bolts 118.

A second removable securing member 120 is connected to the lower portion 96 of the mast 92 via a pivotable bracket 122. The securing member 120 is here shown as a magnet 124 having sufficient strength to secure the mast 92 to the excavating apparatus 82 such that the mast remains fixed during excavation. One example of a suitable magnet is commercially available from JOB MASTER.

The mast assembly 80 is mounted to the excavating assembly by angling the mast 92 so that the second securing member 122 is away from the rear wall 84 of the excavating assembly 82. The latch points 106 of the latch bracket 102 are then inserted into the holes 112 of the adapter plate 110. The extent of insertion of the latch points 106 into the holes 112 is limited by the strap 108. Using the strap 108 as a fulcrum in contact with the adapter plate 110, the mast assembly is rotated to bring the second securing member 122 into contact with the rear wall 84 of the excavating assembly 82. With the mast assembly 80 thus secured, the laser receiver 30″ can be operated as usual.

While details of the invention are discussed herein with reference to some specific examples to which the principles of the present invention can be applied, the applicability of the invention to other devices and equivalent components thereof will become readily apparent to those of skill in the art. For example, the mast 20 can be fabricated from a variety of materials, such as aluminum or composite materials. Similarly, the laser receiver 30 could be provided as any remote position indicating apparatus, and can be combined with other devices such as GPS. Likewise, the mast 20 can be provided with an angled, curved, or straight configuration in order to accommodate various excavating apparatus.

Accordingly, it is intended that all such alternatives, modifications, permutations, and variations to the exemplary embodiments can be made without departing from the scope and spirit of the present invention as defined in the appended claims.

1. A mast assembly for mounting guidance components to an excavator component of an excavating vehicle, the mast assembly comprising the following:
a mast; and
a magnetic removable securing member connected to the mast, the magnetic removable securing member being adapted and constructed for removable connection to a location on the excavator component.

2. A mast assembly for mounting guidance components to an excavator component of an excavating vehicle, the mast assembly comprising the following:
a mast;
a first removable securing member connected to the mast, the first removable securing member being adapted and constructed for removable connection to a first location on the excavator component; and
a second removable securing member connected to the mast at a location spaced from the first removable securing member, the second removable securing member being adapted and constructed for removable connection to a second location on the excavator component;
wherein at least one of the removable securing members includes a magnet.

3. A mast assembly in accordance with claim 2, wherein the second removable securing member comprises a magnet.

4. A mast assembly in accordance with claim 3, further comprising at least one strap element securing the second removable securing member to the mast.

5. A mast assembly in accordance with claim 4, wherein the at least one strap element comprises a pair of adjustable securing straps.

6. A mast assembly in accordance with claim 3, further comprising a pivotable bracket securing the second removable securing member to the mast.

7. A mast assembly in accordance with claim 3, wherein the first removable securing member comprises a hook arrangement comprising at least one hook adapted and constructed to extend through a corresponding number of bores formed in the first location on the excavator component.

8. A mast assembly in accordance with claim 7, wherein the at least one hook comprises a pair of hooks adapted and constructed to extend through a pair of bores formed in the first location on the excavator component.

9. A mast assembly in accordance with claim 8, wherein the mast comprises the following:
an upper portion;
a lower portion; and
an angled portion connecting the upper portion to the lower portion, whereby the first removable securing member is secured to the upper portion of the mast, and the second removable securing member is secured to the lower portion of the mast.

10. A mast assembly in accordance with claim 3, wherein the first removable securing member comprises a latch assembly comprising the following:
an adapter plate secured to the excavator component; and
a latch bracket including at least one latch point adapted and constructed to extend through a corresponding number of holes formed in the adapter plate.

11. A mast assembly in accordance with claim 10, wherein the latch bracket includes a curved mast attachment portion rigidly secured to the mast.

12. A mast assembly in accordance with claim 11, wherein the at least one latch point comprises a pair of latch points extending downwardly and outwardly from the curved mast attachment portion.

13. A mast assembly in accordance with claim 12, wherein the latch bracket further includes a flat strap secured between the latch points.

14. A mast assembly in accordance with claim 13, wherein the mast comprises the following:
an upper portion;
a lower portion; and
an angled portion connecting the upper portion to the lower portion, whereby the first removable securing member is secured to the upper portion of the mast, and the second removable securing member is secured to the lower portion of the mast.

15. A method of securing a mast assembly to an excavator component of an excavating vehicle, the method comprising the following steps:
providing a mast assembly having a first removable securing member connected to the mast and including at least one insertion member, and a second removable securing member connected to the mast at a location spaced from the first removable securing member and including a magnet;
providing receiving structure on the excavator component of the excavating vehicle, the receiving structure being capable of receiving the at least one insertion member of the first removable securing member;
angling the mast assembly so that the second securing member is spaced from the excavator component;
inserting the insertion member into the receiving structure; and
rotating the mast assembly to bring the second securing member into magnetic contact with the excavator component.
